(19) United States
(12) Patent Application Publication
(10) Pub. No.: US 2026/0153822 A1
(43) Pub. Date: Jun. 4, 2026

(54) FIXING DEVICE AND IMAGE FORMING APPARATUS

(71) Applicant: FUJIFILM Business Innovation Corp., Tokyo (JP)

(72) Inventors: Yasushi FUJIWARA, Kanagawa (JP); Motoyuki YAGI, Kanagawa (JP); Taisei SEO, Kanagawa (JP); Noriaki KISHI, Kanagawa (JP)

(73) Assignee: FUJIFILM Business Innovation Corp., Tokyo (JP)

(21) Appl. No.: 19/191,541

(22) Filed: Apr. 28, 2025

(30) Foreign Application Priority Data
Nov. 29, 2024 (JP) 2024-207958

(51) Int. Cl. G03G 15/20

(52) U.S. Cl. CPC G03G 15/2053; G03G 15/2064

(57) ABSTRACT

A fixing device includes a rotatable body including a heat source; a tubular belt to be rotated while being in contact with an outer peripheral surface of the rotatable body; a counter member provided on an inner peripheral side of the belt and having a counter surface that faces toward the outer peripheral surface of the rotatable body; a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and an elastic member attached to the counter surface while being in contact with a lateral face of the raised portion, the elastic member being configured to press the belt against the outer peripheral surface of the rotatable body in such a manner as to form an upstream nip, in which a corner of the raised portion is recessed to form a recessed corner, the corner being oriented toward the counter surface.

### CROSS-REFERENCE TO RELATED APPLICATIONS

This application is based on and claims priority under 35 USC 119 from Japanese Patent Application No. 2024-207958 filed Nov. 29, 2024.

### BACKGROUND

### (i) Technical Field

The present disclosure relates to a fixing device and an image forming apparatus.

### (ii) Related Art

A fixing device disclosed in Japanese Unexamined Patent Application Publication No. 2005-37678 (Claims 1 to 4, paragraphs 0063 to 0065, and FIG. 6) includes a heating roll, a fixing belt, a first pad, and a second pad.

The heating roll includes a heat source. The fixing belt is an endless belt that is to be rotated. The first pad is a hard pad provided to an inner belt-supporting member and makes the nip pressure even in the axial direction. The second pad is a soft pad provided to the inner belt-supporting member at a position on the upstream side relative to the first pad in the rotation direction of the fixing belt. The second pad has a greater coefficient of friction than the first pad.

A fixing device disclosed in Japanese Unexamined Patent Application Publication No. 2016-18161 (Claim 1, paragraph 0025, and FIGS. 2 and 4) includes a fixing belt, a fixing-belt-holding member, a pressure roller, a heat source, a nip-forming member, and so forth.

The fixing-belt-holding member holds two ends of the fixing belt. The heat source is a halogen heater or the like configured to heat the fixing belt. The nip-forming member is a pad to be brought into contact with the pressure roller with the fixing belt in between, thereby forming a nip. The nip-forming member is supported by a nip-supporting member.

### SUMMARY

Aspects of non-limiting embodiments of the present disclosure relate to a fixing device in which a portion of an elastic member configured to form an upstream nip is prevented from riding on the top face of a raised portion configured to form a downstream nip.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including a rotatable body including a heat source; a tubular belt to be rotated while being in contact with an outer peripheral surface of the rotatable body; a counter member provided on an inner peripheral side of the belt and having a counter surface that faces toward the outer peripheral surface of the rotatable body; a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and an elastic member attached to the counter surface while being in contact with a lateral face of the raised portion, the elastic member being configured to press the belt against the outer peripheral surface of the rotatable body in such a manner as to form an upstream nip, wherein A corner of the raised portion is recessed to form a recessed corner, the corner being oriented toward the counter surface.

### BRIEF DESCRIPTION OF THE DRAWINGS

An exemplary embodiment of the present disclosure will be described in detail based on the following figures, wherein:

FIG. 1 is an overview of an image forming apparatus including a fixing device according to an exemplary embodiment;

FIG. 2 is a schematic sectional view of the fixing device according to the exemplary embodiment;

FIG. 3 is an enlarged schematic sectional view of a part of the fixing device illustrated in FIG. 2;

FIG. 4A is a schematic sectional view of a counter member;

FIG. 4B is a schematic perspective view of a part of the counter member illustrated in FIG. 4A;

FIG. 5A illustrates a recessed corner;

FIG. 5B illustrates a variation of the recessed corner; and

FIG. 6 illustrates a phenomenon in which a portion of the elastic member rides on a comparative raised portion, with an enlargement of the comparative raised portion.

### DETAILED DESCRIPTION

Exemplary embodiments of the present disclosure will now be described.

### Exemplary Embodiment

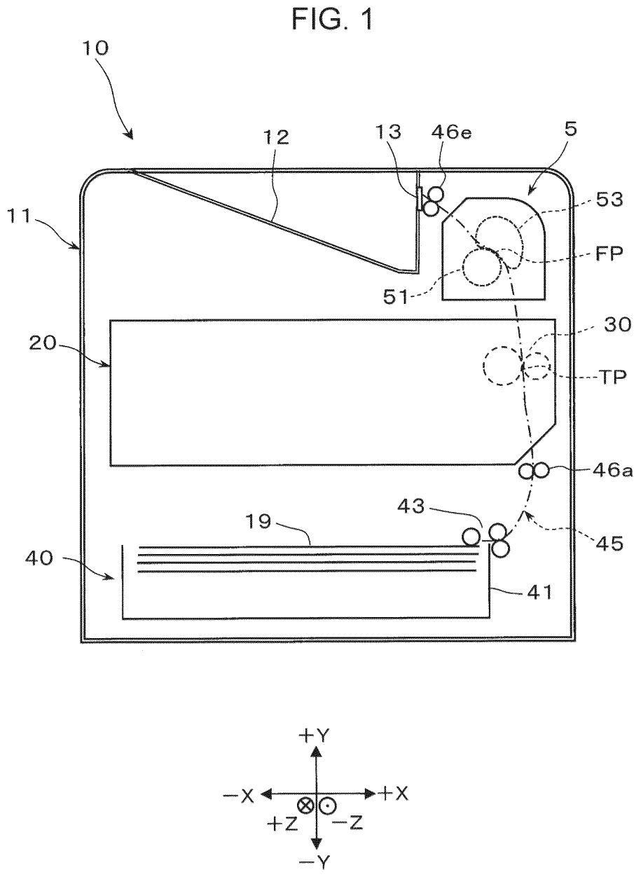

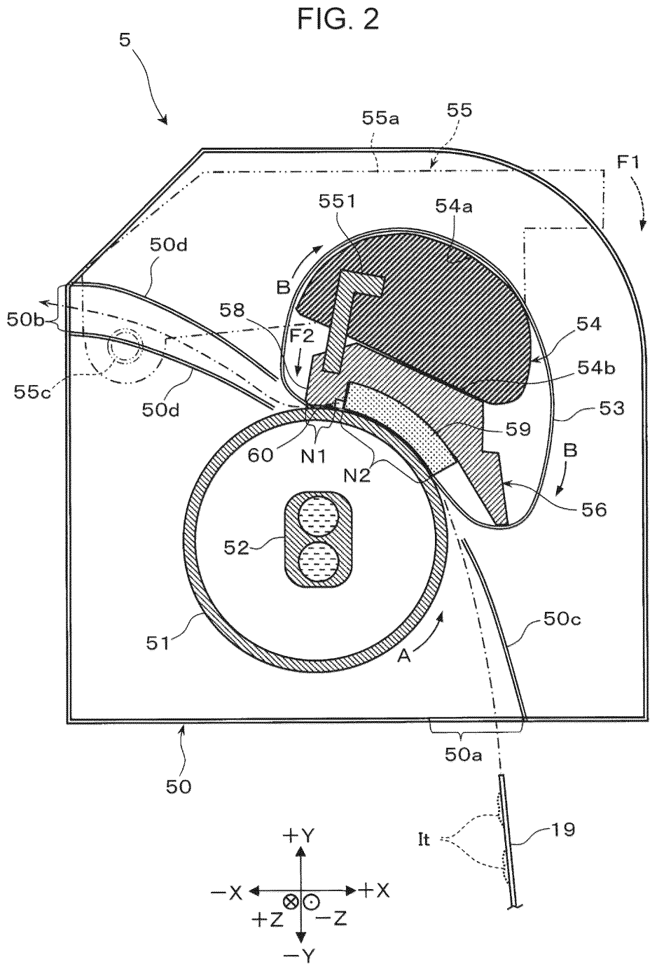

FIG. 1 illustrates an image forming apparatus 10, which includes a fixing device 5 according to an exemplary embodiment. FIG. 2 illustrates the fixing device 5 according to the exemplary embodiment.

In this specification and the drawings, elements that are substantially the same are denoted by the same reference signs. In this specification, redundant description of substantially the same elements is omitted.

In FIG. 1 and others, reference signs +X and −X denote the rightward direction and the leftward direction, respectively, of the image forming apparatus 10 and other relevant elements in front view. Reference signs +Y and −Y denote the upward direction and the downward direction, respectively, of the image forming apparatus 10 and other relevant elements. Reference signs +Z and −Z denote the far side and the near side, respectively, in the depthwise direction of the image forming apparatus 10 and other relevant elements in front view.

In FIG. 1 and others, the circle with a cross represents the direction from the near side toward the far side relative to the plane of the page in the drawings. Furthermore, the circle with a dot represents the direction from the far side toward the near side relative to the plane of the page in the drawings.

### (1) Image Forming Apparatus

The image forming apparatus 10 is configured to form a predetermined image on a sheet 19. The image is any expression that contains visible information such as text, diagrams, photographs, and patterns.

The image forming apparatus 10 has an internal space defined by a housing 11. An imaging device 20, a sheet feeding device 40, the fixing device 5, and other relevant elements are provided in the internal space.

Furthermore, a power feeding device, a rotary driving device, a control device, and so forth (not illustrated) are provided in the internal space of the housing 11. An operation panel and so forth (not illustrated) are provided on the outer side of the housing 11.

The housing 11 is a box-like structure having an external shape and the internal space that are predetermined.

The housing 11 is constituted by, for example, frames, plates, exterior members, and so forth.

The housing 11 has at the top thereof an output accommodation part 12, which is configured to receive and accommodate any sheets 19 each having an image formed thereon. A portion of the output accommodation part 12 that forms a side face has an output port 13, which allows the sheet 19 to pass through to be outputted.

The imaging device 20 is capable of forming an unfixed image on a sheet 19.

The imaging device 20 employs, for example, an electrophotographic imaging scheme.

The imaging device 20 in such a case includes an image carrier, a charging device, an image exposure device, a developing device, a transfer device, a cleaning device, and so forth (not illustrated). The imaging device 20 may be either a device configured to form a monochrome (black, for example) image or a device configured to form a multicolor (color) image.

The image carrier is a rotatable structure, such as a photoconductor drum, having an image-carrying surface on which an image is to be carried. The charging device is configured to charge the image-carrying surface of the image carrier.

The image exposure device is configured to form an electrostatic latent image by performing exposure on the charged image-carrying surface of the image carrier in accordance with image information. The image information relates to an image that is inputted to the image forming apparatus 10 from an external device or the like.

The developing device is configured to develop with a developer the electrostatic latent image formed on the image-carrying surface of the image carrier into an unfixed image. The unfixed image is, for example, a toner image obtained through the development.

The transfer device is configured to transfer the unfixed image formed on the image carrier to a sheet 19.

The transfer device employs a direct transfer scheme or an intermediate transfer scheme. The direct transfer scheme is intended to directly transfer an unfixed image to a sheet 19. The intermediate transfer scheme is intended to transfer an unfixed image to an intermediate transfer body in a first transfer process and then to a sheet 19 in a second transfer process.

In FIG. 1, a part configured to transfer an unfixed image to a sheet 19 is illustrated as a transfer part 30. The transfer part 30 has a transfer position TP, where a sheet 19 is made to pass so that an unfixed image is transferred thereto.

The cleaning device is configured to clean the image-carrying surface of the image carrier and/or the image-carrying surface of the intermediate transfer body.

The sheet feeding device 40 is configured to accommodate predetermined sheets 19 and to feed each of the sheets 19 to the imaging device 20.

The sheet feeding device 40 includes an accommodation member 41, which is configured to accommodate sheets 19; and a delivering device 43, which is configured to deliver the sheets 19 one by one from the accommodation member 41. The accommodation member 41 and the delivering device 43, which are provided in one pair in FIG. 1, may be provided in multiple pairs.

The sheets 19 are each a recording medium that is transportable in the housing 11 and is handleable by the imaging device 20 in operations such as the transfer of an unfixed image. The sheet 19 may be any sheet-type recording medium having a predetermined size.

The fixing device 5 is configured to fix the unfixed image formed by the imaging device 20 to the sheet 19.

The fixing device 5 has a fixing housing 50, in which a heating roll 51, a belt 53, and other relevant elements are provided. The heating roll 51 is an exemplary rotatable body provided for heating. The belt 53 is an exemplary rotatable body provided for pressing.

In the fixing device 5, a part where the heating roll 51 and the belt 53 are in contact with each other is defined as a fixing position FP, where the sheet 19 is made to pass for a fixing operation.

Details of the fixing device 5 will be described separately below.

A sheet transport path 45 runs through the internal space of the housing 11 and is illustrated by a one-dot chain line in FIG. 1 and others.

The sheet transport path 45 includes a transport path extending from the sheet feeding device 40 through the imaging device 20 and the fixing device 5 to the output port 13. The transport path is intended to transport the sheet 19 through the transfer position TP defined in the imaging device 20 and the fixing position FP defined in the fixing device 5.

The sheet transport path 45 is constituted by a predetermined number of pairs of transporting rolls 46a and 46e and other relevant elements (not illustrated) such as transport guiding members.

### (2) Image Forming Operation

The image forming apparatus 10 is configured to perform the following image forming operation.

The following description is based on an assumption that the imaging device 20 forms a monochrome image.

When the control device (not illustrated) of the image forming apparatus 10 receives a command for an image forming operation, the imaging device 20, the sheet feeding device 40, the fixing device 5, and other relevant elements are activated.

Accordingly, the image carrier of the imaging device 20 starts to rotate in a predetermined direction. In the imaging device 20, the rotating image carrier undergoes a charging operation, an exposure operation, a development operation, a transfer operation, and a cleaning operation.

Meanwhile, in the sheet feeding device 40 and the sheet transport path 45, a sheet feeding operation is performed synchronously with the transfer operation.

Thus, in the imaging device 20, an unfixed image is formed on the image carrier. The transfer part 30 of the imaging device 20 receives a predetermined sheet 19 delivered from the sheet feeding device 40 along the sheet transport path 45.

In the imaging device 20, the unfixed image on the image carrier is transferred to the sheet 19 at the transfer position TP defined in the transfer part 30.

In the fixing device 5, the heating roll 51 and the belt 53 start to rotate. Furthermore, in the fixing device 5, the heating roll 51 is heated to a temperature that enables a fixing operation.

In the fixing device 5, after the heating roll 51 reaches the temperature that enables the fixing operation, the fixing operation is performed.

In the fixing device 5, the sheet 19 having the unfixed image transferred thereto is introduced into the fixing housing 50 and is made to pass through the fixing position FP.

Thus, in the fixing device 5, the unfixed image on the sheet 19 is heated under pressure when passing through the fixing position FP and is fixed to the sheet 19.

Lastly, in the image forming apparatus 10, the sheet 19 having undergone the fixing operation in the fixing device 5 is transported along the sheet transport path 45 to the output port 13.

Then, the sheet 19 having undergone the fixing operation is outputted from the output port 13 by the pair of transporting rolls 46e and is accommodated by the output accommodation part 12.

Through the above series of operations, a basic image forming operation of forming an image on one side of one sheet 19 is complete.

### (3) Fixing Device

The fixing device 5 has the fixing housing 50 (see FIG. 2).

The fixing device 5 includes inside the fixing housing 50 the heating roll 51, the belt 53, a counter member 56, an elastic member 59, and so forth.

The fixing housing 50 is a box-like structure having an external shape and an internal space that are predetermined.

The fixing housing 50 has an inlet 50a and an outlet 50b for the sheet 19.

In the internal space of the fixing housing 50 are provided an introduction guiding member 50c, a discharge guiding member 50d, and so forth. Inside the fixing housing 50 is further provided a temperature sensor or the like (not illustrated) configured to detect the surface temperature of the heating roll 51.

The fixing housing 50 is fixed at a predetermined position in the housing 11 of the image forming apparatus 10.

The heating roll 51 is a structure including a circular cylindrical roll base that is made of metal or the like; and any relevant layers, such as a release layer, provided on the outer peripheral surface of the roll base.

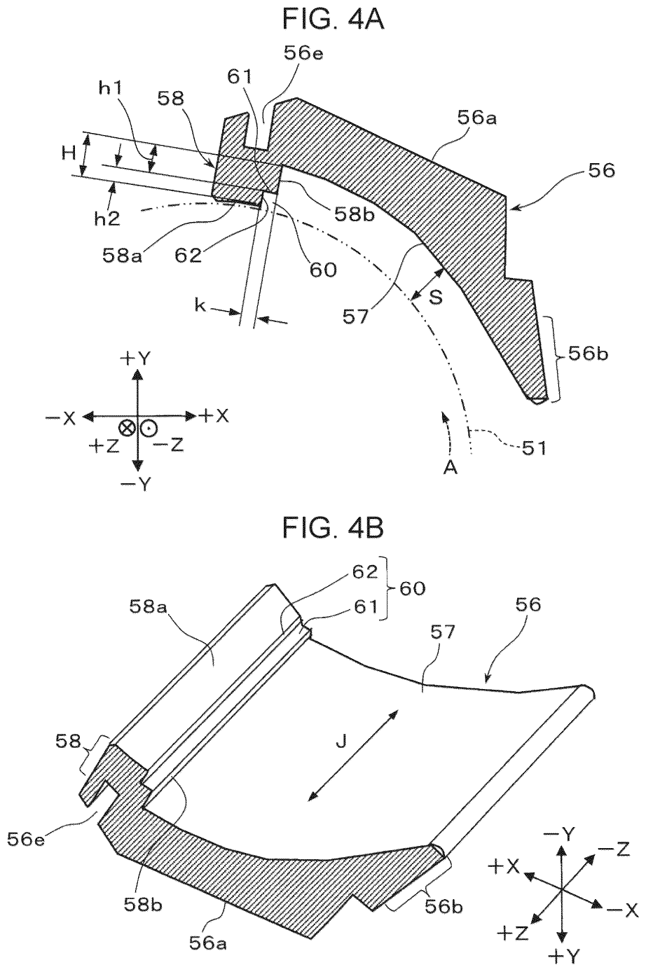

The heating roll 51 is rotatably attached to the fixing housing 50 with the aid of bearings or the like provided at two respective ends, in an axial direction J (see FIG. 4B), of the heating roll 51. The axial direction J is parallel to the depthwise direction Z of the image forming apparatus 10.

A receiving gear (not illustrated) is provided at the far-side end of the heating roll 51 in the axial direction J. Power generated by a rotary driving device (not illustrated) is to be transmitted to the receiving gear. When the fixing operation and other relevant operations are started, the heating roll 51 is rotated in a rotation direction A.

The heating roll 51 has an internal space in which a halogen heater lamp 52 is provided. The halogen heater lamp 52 is an exemplary heat source.

The halogen heater lamp 52 is fixedly provided in the internal space of the heating roll 51 and extends parallel to the axial direction J of the heating roll 51.

The halogen heater lamp 52 is configured to generate heat by receiving a predetermined electric power from a power feeding device (not illustrated) and thus heat the heating roll 51.

The belt 53 is a tubular member that is to be rotated while being in contact with the outer peripheral surface of the heating roll 51.

A member employed as the belt 53 includes a cylindrical belt base and any relevant layers provided on the outer peripheral surface of the belt base. The belt base is made of polyimide resin or the like. Examples of the relevant layers include a heat-resistant release layer.

The belt 53 is rotatably held by a belt holding member 54, the counter member 56, the elastic member 59, and other relevant elements that are provided on the inner peripheral side thereof.

The belt holding member 54 provided on the inner peripheral side of the belt 53 extends parallel to the axial direction J of the heating roll 51.

The belt holding member 54 has a belt holding surface 54a and a pressing surface 54b (see FIG. 2).

The belt holding surface 54a is a curved surface at which the inner peripheral surface of the belt 53 is slidably held from below. The pressing surface 54b is a substantially flat surface that is in contact with a portion of the counter member 56 and at which the counter member 56 is to be pressed. The portion of the counter member 56 serves as a pressure receiving surface 56a, to be described below.

The belt holding member 54 is attached to a pressing mechanism 55 with the aid of a supporting member 551 (see FIG. 2).

The supporting member 551 supports the belt holding member 54 and is configured to transmit a pressing effect produced by the pressing mechanism 55 to the belt holding member 54.

The supporting member 551 is a plate extending parallel to the axial direction J of the heating roll 51.

The supporting member 551 according to the exemplary embodiment is a metal plate whose upper portion is bent.

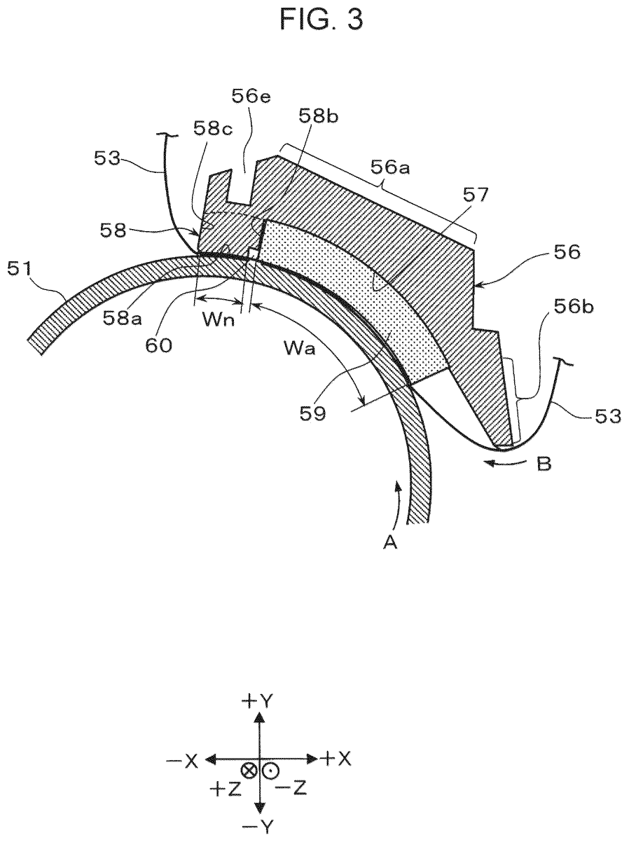

The supporting member 551 is fixed such that the bent upper portion thereof is present inside the belt holding member 54. A lower portion (lower end portion) of the supporting member 551 is fitted in an insertion groove 56e (see FIG. 3), which is provided in the counter member 56.

Two ends of the supporting member 551 in the long-side direction thereof are attached to respective swing arms 55a, which are included in the pressing mechanism 55 and will be described below.

The pressing mechanism 55 includes the swing arms 55a and other relevant elements (not illustrated) such as a pressing component.

The swing arms 55a are swingable about a supporting shaft 55c. The two ends of the supporting member 551 are attached to the respective swing arms 55a. The swing arms 55a are a pair of arms each extending over a corresponding one of the ends of the heating roll 51 from above. The supporting shaft 55c is fixed to, for example, a portion of the fixing housing 50.

The pressing component is configured to apply a predetermined pressure F1 (see FIG. 2) to the swing arms 55a such that the swing arms 55a swing toward the heating roll 51. The pressing component is any one or combination of a tension spring, a compression spring, a cam, and so forth.

The belt holding member 54 receives the predetermined pressure F1 from the pressing mechanism 55 through the supporting member 551.

Accordingly, the pressing surface 54b of the belt holding member 54 comes into contact with and is pressed against the pressure receiving surface 56a of the counter member 56. The supporting member 551 in such a state directly transmits the pressing effect from the pressing mechanism 55 to the insertion groove 56e of the counter member 56.

Thus, the belt holding member 54 cooperates with the supporting member 551 to press the counter member 56 toward the heating roll 51.

The counter member 56 is located on the inner peripheral side of the belt 53 and faces toward the outer peripheral surface of the heating roll 51.

The counter member 56 is a plate-like member having a raised portion 58 and a counter surface 57. The counter member 56 is also shaped to have the pressure receiving surface 56a, a belt guiding portion 56b, and the insertion groove 56e.

The counter member 56 is obtained by, for example, molding of synthetic resin or the like.

Two ends of the counter member 56 in the long-side direction thereof are attached to the fixing housing 50 and are displaceable relative to the fixing housing 50. That is, the counter member 56 is displaceable in a direction in which the counter surface 57 and the raised portion 58 are brought toward and away from the outer peripheral surface of the heating roll 51.

The raised portion 58 of the counter member 56 is a portion of the counter surface 57 that is raised at an end of the counter surface 57 on the downstream side in the rotation direction A of the heating roll 51.

The raised portion 58 is configured to press the belt 53 against the outer peripheral surface of the heating roll 51 in such a manner as to form a downstream nip N1 (see FIG. 2). The nip refers to a contact part that is formed under pressure.

The raised portion 58 is raised from the counter surface 57 of the counter member 56 toward the heating roll 51 by a predetermined height H (see FIG. 4A).

The raised portion 58 extends parallel to the axial direction J of the heating roll 51.

The raised portion 58 has a substantially rectangular sectional shape.

The raised portion 58 has a top face 58a, an upstream lateral face 58b, a downstream lateral face 58c, and so forth.

The top face 58a forms a surface at which the belt 53 is pressed against the outer peripheral surface of the heating roll 51 and at which the downstream nip N1 is formed. The top face 58a forms a curved surface that is convex toward the raised side of the raised portion 58. The top face 58a of the raised portion 58 comes into contact with the heating roll 51 over an area having a nip width Wn (see FIG. 3) in the rotation direction A of the heating roll 51, thereby forming the downstream nip N1.

The upstream lateral face 58b extends from the upstream end of the top face 58a to the counter surface 57. The downstream lateral face 58c extends from the downstream end of the top face 58a to the downstream-side end of the counter member 56.

The counter surface 57 of the counter member 56 faces toward the outer peripheral surface of the heating roll 51 with a predetermined gap S in between.

The counter surface 57 extends from the raised portion 58 of the counter member 56 toward the upstream side in the rotation direction A of the heating roll 51.

The counter surface 57 is a curved surface that curves substantially in conformity with the outer peripheral surface of the heating roll 51.

The pressure receiving surface 56a of the counter member 56 is a surface with which the pressing surface 54b of the belt holding member 54 is in contact.

In the counter member 56, the pressure receiving surface 56a is located opposite the counter surface 57. The pressure receiving surface 56a is a flat surface that is facing substantially parallel to the pressing surface 54b of the belt holding member 54.

The belt guiding portion 56b of the counter member 56 is to guide the rotating belt 53 such that the belt 53 is brought close to the heating roll 51 at a predetermined position.

The belt guiding portion 56b extends toward the upstream side in the rotation direction A beyond a portion of the counter surface 57 where the elastic member 59 is attached.

Thus, the belt guiding portion 56b guides the belt 53 such that a portion of the belt 53 that has passed the belt holding member 54 is brought close to the heating roll 51. Specifically, the belt 53 thus guided is brought close to the heating roll 51 at a position before an upstream nip N2, which will be described separately below.

The insertion groove 56e provided in the counter member 56 is a groove in which a lower portion of the above-described supporting member 551 is fitted.

The insertion groove 56e is provided in a portion of the counter member 56 that is located opposite the raised portion 58. The insertion groove 56e extends linearly and parallel to the axial direction J of the heating roll 51. That is, the positions of the insertion groove 56e and the raised portion 58 match each other at the front and back sides, respectively, of the counter member 56.

The elastic member 59 is an elastically deformable member that is attached to the counter surface 57 of the counter member 56.

The elastic member 59 is also configured to press the belt 53 against the outer peripheral surface of the heating roll 51 in such a manner as to form the upstream nip N2 (see FIG. 2).

The elastic member 59 is a plate-like member whose section is substantially rectangular with a thickness (height) and a width Wa, which are predetermined, and extends to a predetermined length.

The elastic member 59 is oriented with the long-side direction thereof being parallel to the axial direction J of the heating roll 51.

The width Wa of the elastic member 59 refers to a dimension in the rotation direction A of the heating roll 51 (see FIG. 3). The width Wa of the elastic member 59 is set to a dimension that corresponds to the width of the upstream nip N2.

The elastic member 59 is made of an elastic material such as silicon sponge.

The elastic member 59 is attached to the counter surface 57 of the counter member 56 with double-faced adhesive tape, an adhesive agent, or the like.

One end of the elastic member 59 thus attached is in contact with the upstream lateral face 58b of the raised portion 58 (see FIG. 3).

In the fixing device 5, the pressing mechanism 55 performs a pressing operation, whereby the counter member 56 receives a pressing effect from the belt holding member 54 and the supporting member 551.

That is, in the fixing device 5, the pressure F1 generated by the pressing mechanism 55 is transmitted to the counter member 56 through the belt holding member 54 and the supporting member 551.

Thus, in the fixing device 5, the counter member 56 is subjected to a pressure acting in such a direction as to bring the counter member 56 close to the outer peripheral surface of the heating roll 51.

In such a state, the raised portion 58 of the counter member 56 is kept being pressed against the outer peripheral surface of the heating roll 51 with the belt 53 in between.

The raised portion 58 in the above state is pressed substantially by the supporting member 551.

Thus, the raised portion 58 is pressed against the outer peripheral surface of the heating roll 51 with a predetermined pressure F2 (see FIG. 2).

Consequently, the raised portion 58 forms the downstream nip N1 at the outer peripheral surface of the heating roll 51 with the belt 53 in between. The downstream nip N1 formed by the raised portion 58 has the nip width Wn.

The downstream nip N1 is regarded as a site where the raised portion 58 substantially applies the pressure F2 to the sheet 19 and the unfixed image over an area having the nip width Wn.

In such a state, the elastic member 59 is kept being pressed against the outer peripheral surface of the heating roll 51 with the belt 53 in between.

In other words, the elastic member 59 is pressed against the outer peripheral surface of the heating roll 51 by the counter surface 57 of the counter member 56.

Accordingly, the elastic member 59 is elastically deformed while being pressed against the outer peripheral surface of the heating roll 51 with the belt 53 in between.

That is, when in use, the elastic member 59 has a thickness smaller than before the fixing device 5 is assembled (when under no load).

Consequently, the elastic member 59 forms the upstream nip N2 at the outer peripheral surface of the heating roll 51 with the belt 53 in between. The upstream nip N2 thus formed has a nip width substantially equal to the width Wa of the elastic member 59.

The upstream nip N2 is formed by the elastically deformable elastic member 59. That is, the upstream nip N2 is regarded as a site where a pressure lower than the pressure F2 for the downstream nip N1 is applied to the sheet 19 and the unfixed image.

The nip width (substantially the width Wa) of the upstream nip N2 is greater than the nip width Wn of the downstream nip N1. The nip width of the upstream nip N2 may be set to, for example, a dimension greater than or equal to three times the nip width Wn of the downstream nip N1. That is, the upstream nip N2 is regarded as a site where heat and a weak pressure are applied to the sheet 19 and the unfixed image for a longer period than at the downstream nip N1.

### (4) Fixing Operation

When the fixing device 5 receives a command for a fixing operation, the heating roll 51 starts to rotate in the rotation direction A.

Accordingly, the belt 53 receives a rotational force from the heating roll 51 at the upstream nip N2 and the downstream nip N1 and rotates in a direction B by following the heating roll 51. The belt 53 thus rotating is held by the belt holding member 54 and is guided by the belt guiding portion 56b of the counter member 56. The belt 53 thus rotating moves in a circular manner while being in contact with the outer peripheral surface of the heating roll 51 and passing through the upstream nip N2 and the downstream nip N1.

In such a state, the heating roll 51 is heated to a predetermined temperature under a heat generating operation of the halogen heater lamp 52. The heating roll 51 thus heated makes the upstream nip N2 and the downstream nip N1 through which the belt 53 passes be ready for a heating process.

When the fixing device 5 becomes ready for the fixing operation, a sheet 19 having an unfixed image It (see FIG. 2) transferred thereto is introduced into the fixing housing 50.

The sheet 19 when introduced is oriented such that the side having the transferred unfixed image It faces the heating roll 51.

Furthermore, the sheet 19 when introduced is guided by the introduction guiding member 50c and moves to a position where the heating roll 51 and the belt 53 start to come into contact with each other.

Then, the sheet 19 is transported while being nipped between the heating roll 51 and the belt 53 that are rotating.

Specifically, the sheet 19 thus transported passes through the upstream nip N2 and the downstream nip N1 in that order.

Accordingly, the sheet 19 having the transferred unfixed image It is heated under pressure while passing through the upstream nip N2 and the downstream nip N1.

Consequently, the unfixed image It is fused with the heat and is fixed to the sheet 19.

In this process, the unfixed image It and the sheet 19 receive a relatively weak pressurizing force at the upstream nip N2. Subsequently, the unfixed image It and the sheet 19 receives a relatively strong pressurizing force (F2) at the downstream nip N1.

That is, the fixing device 5 firstly performs a preliminary fixing process at the upstream nip N2, and secondly performs a finishing fixing process at the downstream nip N1.

When the fixing operation ends in the fixing device 5, the sheet 19 is guided by the discharge guiding member 50d and is discharged to the outside of the fixing housing 50.

The sheet 19 to be discharged is released from the heating roll 51 after passing through the downstream nip N1.

Through the above series of processes, a fixing operation that is performed on one sheet 19 by the fixing device 5 is complete.

### (5) Problems

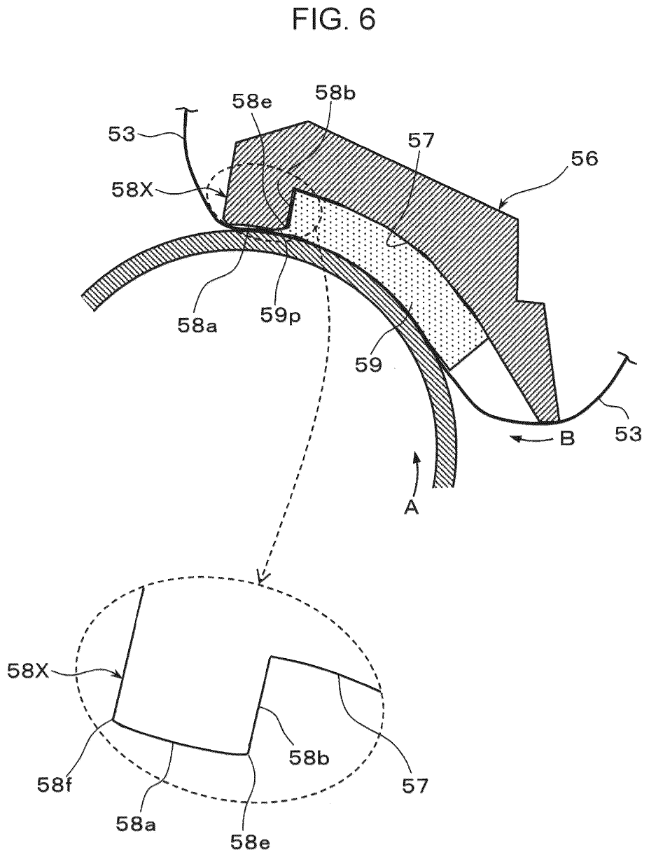

If the fixing device 5 employs a comparative raised portion 58X illustrated in FIG. 6, the fixing device 5 may involve the following problems.

The comparative raised portion 58X has a corner 58e, which is oriented toward the counter surface 57 and projects outward. The corner 58e forms an outward projection at the intersection (edge) between the top face 58a and the upstream lateral face 58b of the raised portion 58X.

If the raised portion 58X having the corner 58e is employed, a portion of the deformed elastic member 59 may ride on the top face 58a of the raised portion 58X.

Reference sign 59p given in FIG. 6 denotes a portion of the elastic member 59 that has ridden on the top face 58a of the raised portion 58X. Reference sign 58f given in FIG. 6 denotes a corner of the raised portion 58X that is oriented away from the counter surface 57. Assuming that the corner 58e is the upstream corner, the corner 58f is the downstream corner.

If a portion of the elastic member 59 rides on the top face 58a of the raised portion 58X, particularly the pressurizing force applied to the downstream nip N1 deviates from the design value.

In the fixing device 5, such a fluctuation in the pressurizing force tends to trigger fixing failure and/or wrinkles in the sheet 19.

The riding of a portion of the elastic member 59 may also occur during the assembly of the fixing device 5.

### (6) Additional Configuration of Fixing Device

In view of the above, in the fixing device 5, a corner (58e, see FIG. 6) of the raised portion 58 that is oriented toward the counter surface 57 forms a recessed corner 60.

The recessed corner 60 has an inwardly recessed shape.

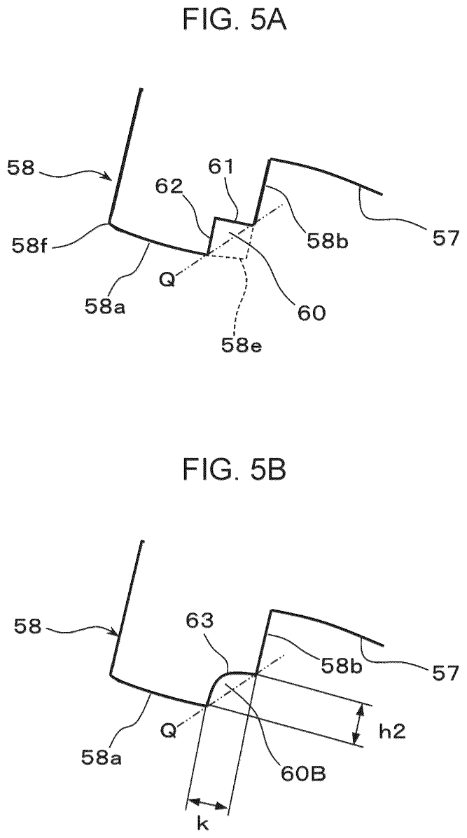

The expression “inwardly recessed” refers to a state of being recessed to the inner side relative to a virtual line or plane Q (see FIG. 5A), which connects the top face 58a and the upstream lateral face 58b to each other. The top face 58a and the upstream lateral face 58b adjoin the recessed corner 60.

The recessed corner 60 encompasses neither a tapered corner that is obtained through oblique cutting along a plane nor a chamfered corner that has an outwardly curved surface.

The recessed corner 60 continuously extend in a direction parallel to the axial direction J of the heating roll 51 (see FIG. 4B). The recessed corner 60 extending parallel to the axial direction J is longer than the elastic member 59 in the axial direction J.

The shape of a section of the recessed corner 60 that is taken along a plane orthogonal to the axial direction J is constant in the axial direction J. In other words, there are no variations in the sectional shape of the recessed corner 60 in the axial direction J.

The recessed corner 60 is recessed from the upstream lateral face 58b of the raised portion 58 toward the downstream side in the rotation direction A of the heating roll 51.

The recessed corner 60 according to the exemplary embodiment has a rectangular sectional shape defined by a first face 61 and a second face 62. The first face 61 extends from the upstream lateral face 58b toward the recessed side. The second face 62 extends from an end of the first face 61 that is at the terminal of the recess toward the top face 58a.

The recessed corner 60 configured as above is recessed by a dimension h2 (see FIG. 4A), which is smaller than or equal to ⅓ of the height H of the raised portion 58. The height H of the raised portion 58 refers to a dimension by which the raised portion 58 is raised from the counter surface 57 of the counter member 56. Reference sign h1 given in FIG. 4A denotes the height of the upstream lateral face 58b from the counter surface 57.

If the recessed corner 60 is recessed by a dimension greater than ⅓ of the height H of the raised portion 58, the area of contact between the elastic member 59 and the upstream lateral face 58b becomes insufficient. Consequently, the elastic member 59 becomes more likely to elastically deform into the recess provided at the recessed corner 60.

The dimension, k (see FIG. 4A), of the downstreamward recess at the recessed corner 60 of the raised portion 58 may be small. The dimension k of the downstreamward recess refers to the dimension of the recess at the recessed corner 60 where the upstream lateral face 58b is recessed toward the downstream side in the rotation direction A of the heating roll 51.

The dimension k of the downstreamward recess at the recessed corner 60 may be set smaller than or equal to ⅛ of the width of the top face 58a (the nip width Wn). For example, the dimension k of the recess may be set within a range of 1 mm or smaller.

In the fixing device 5 employing the raised portion 58 having the recessed corner 60, even if a portion of the elastic member 59 undergoes a small amount of elastic deformation, the portion behaves as follows.

In the fixing device 5, the elastically deformed portion of the elastic member 59 is temporarily accommodated in the recess provided at the recessed corner 60.

### Variations

The present disclosure is not limited to the exemplary embodiment described above.

The present disclosure may be changed according to need, unless the essence of the present disclosure that are disclosed in Summary are changed.

Specifically, the present disclosure encompasses the following variations.

Referring to FIG. 5B, the recessed corner 60 of the raised portion 58 may be replaced with a recessed corner 60B, which is recessed inward while curving.

The recessed corner 60B is defined by one inwardly curved recessed surface 63.

The halogen heater lamp 52 serving as the heat source included in the heating roll 51 may be replaced with any other heat source. Examples of the heat source include a heat-generating resistance layer, an electromagnetic induction-heating layer, and an external heating device.

The heating roll 51 of the fixing device 5 may be replaced with a rotatable body in the form of a belt that is intended for heating and is supported by multiple rolls.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A fixing device comprising:
a rotatable body including a heat source;
a tubular belt to be rotated while being in contact with an outer peripheral surface of the rotatable body;
a counter member provided on an inner peripheral side of the belt and having a counter surface that faces toward the outer peripheral surface of the rotatable body;
a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and
an elastic member attached to the counter surface while being in contact with a lateral face of the raised portion, the elastic member being configured to press the belt against the outer peripheral surface of the rotatable body in such a manner as to form an upstream nip,
wherein a corner of the raised portion is recessed to form a recessed corner, the corner being oriented toward the counter surface.
   (((2)))

The Fixing Device According to (((1))),
wherein the recessed corner extends continuously in a direction parallel to an axial direction of the rotatable body.
   (((3)))

The fixing device according to (((1))) or (((2))),
wherein the recessed corner has a sectional shape that is constant in the axial direction.
   (((4)))

The fixing device according to any one of (((1))) to (((3))),
wherein the recessed corner is recessed from the lateral face of the raised portion toward the downstream side in the rotation direction of the rotatable body.
   (((5)))

The Fixing Device According to (((4))),
wherein the recessed corner is recessed by a dimension that is smaller than or equal to ⅓ of a height by which the raised portion is raised from the counter surface of the counter member.
   (((6)))

An image forming apparatus comprising the fixing device according to any one of (((1))) to (((5))).

What is claimed is:

1. A fixing device comprising:
a rotatable body including a heat source;
a tubular belt to be rotated while being in contact with an outer peripheral surface of the rotatable body;
a counter member provided on an inner peripheral side of the belt and having a counter surface that faces toward the outer peripheral surface of the rotatable body;
a raised portion provided as a portion of the counter surface and raised at an end of the counter surface, the end being on a downstream side in a rotation direction of the rotatable body, the raised portion being configured to press the belt against the outer peripheral surface of the rotatable body in such a manner as to form a downstream nip; and
an elastic member attached to the counter surface while being in contact with a lateral face of the raised portion, the elastic member being configured to press the belt against the outer peripheral surface of the rotatable body in such a manner as to form an upstream nip,
wherein a corner of the raised portion is recessed to form a recessed corner, the corner being oriented toward the counter surface.

2. The fixing device according to claim 1,
wherein the recessed corner extends continuously in a direction parallel to an axial direction of the rotatable body.

3. The fixing device according to claim 2,
wherein the recessed corner has a sectional shape that is constant in the axial direction.

4. The fixing device according to claim 1,
wherein the recessed corner is recessed from the lateral face of the raised portion toward the downstream side in the rotation direction of the rotatable body.

5. The fixing device according to claim 4,
wherein the recessed corner is recessed by a dimension that is smaller than or equal to ⅓ of a height by which the raised portion is raised from the counter surface of the counter member.

6. An image forming apparatus comprising the fixing device according to claim 1.

7. An image forming apparatus comprising the fixing device according to claim 2.

8. An image forming apparatus comprising the fixing device according to claim 3.

9. An image forming apparatus comprising the fixing device according to claim 4.

10. An image forming apparatus comprising the fixing device according to claim 5.
